(19) United States
(12) Patent Application Publication
(10) Pub. No.: US 2023/0114771 A1
(43) Pub. Date: Apr. 13, 2023

(54) TARGET TRIGGERED IO CLASSIFICATION USING COMPUTATIONAL STORAGE TUNNEL

(71) Applicant: Intel Corporation, Santa Clara, CA (US)

(72) Inventors: Mariusz BARCZAK, Gdansk (PL); Jan MUSIAL, Gdansk (PL)

(21) Appl. No.: 18/078,873

(22) Filed: Dec. 9, 2022

(51) Int. Cl. G06F 9/455; G06F 9/4401

(52) U.S. Cl. CPC G06F 9/45558; G06F 9/4406; G06F 2009/45579; G06F 2009/45583; G06F 2009/4557

(57) ABSTRACT

Methods and apparatus for target triggered IO classification using a computational storage tunnel. A multi-tier memory and storage scheme employing multiple tiers of memory and storage supporting different Input-Output (IO) classes is implemented in an environment including a compute platform. For an IO storage request originating from an application running on the compute platform, an IO class to be used for the request is determined. The IO storage request is then forwarded to a device implementing a memory or storage tier supporting the IO class or via which a device implementing a memory or storage tier supporting the IO class can be accessed. The storage tiers may include local storage in the platform and/or storage accessed via a fabric or network. The storage tiers may implement different types of memory supporting non-volatile storage, with different performance, capacity, and/or endurance, such as a hot and cold tier.

### BACKGROUND INFORMATION

From media perspective, modern storage systems consist of heterogenous storage media. For example, a system may include a “hot” tier memory class storage device (e.g., Optane® SSD (solid-state drive), SLC (single-level cell) Flash) to provide high performance and endurance. A “cold” or “capacity” tier may employ a capacity device (e.g., NAND Quad-level cell (QLC, 4 bits per cell) or Penta-level cell (PLC, 5 bits per cell)) to deliver capacity at low cost but with lower performance and endurance.

Historically, platforms such as servers had their own storage resources, such as one or more mass storage devices (e.g., magnetic/optical hard disk drives or SSDs). Under such platforms different classes of storage media could be detected and selective access to the different classes could be managed by an operating system (OS) or applications themselves. In contrast, today's data center environments employ disaggregated storage architectures under which one or more tiers of storage are accessed over a fabric or network. Under these environments it is common for the storage resources to be abstracted as storage volumes. This may also be the case for virtualized platforms where the Type-1 or Type-2 hypervisor or virtualization layer presents physical storage devices as abstract storage resources (e.g., volumes). While abstracting the physical storage devices provides some advantages, it hides the input-output (IO) context on the disaggregated storage side.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating an overview of a multi-tier memory and storage scheme, according to one embodiment;

FIG. 2 illustrates some recent evolution of compute and storage disaggregation, including Web scale/hyper converged, rack scale disaggregation, and complete disaggregation configurations;

FIG. 3 is a schematic diagram illustrating an example of a disaggregated architecture in which compute resources in compute bricks are connected to disaggregated memory in memory bricks;

FIG. 4 is a message flow diagram that is implemented to configure an environment to support IO classification and employ IO classification for storage on a target;

FIG. 4a is a message flow diagram 400a illustrating a portion of messages and associated operations when the target is a remote storage server, according to one embodiment;

FIG. 5 is a schematic diagram of a cloud environment in which four or five tiers of memory and storage are implemented;

FIG. 6a is a schematic diagram illustrating a high-level view of a system architecture according to an exemplary implementation of a system in which remote pooled memory is used in a far memory/storage tier;

FIG. 6b is a schematic diagram illustrating a high-level view of a system architecture including a compute platform in which a CXL memory card is implemented in a local memory/storage tier;

FIG. 7a is a schematic diagram illustrating an example of a bare metal cloud platform architecture in which aspects of the embodiments herein may be deployed;

FIG. 7b is a schematic diagram illustrating an embodiment of platform architecture employing a Type-2 Hypervisor or Virtual Machine Monitor that runs over a host operating system; and

FIG. 8 is a flowchart illustrating operations performed by a platform employing the NVMeOF protocol and an IO classification program that is a registered eBPF program.

### DETAILED DESCRIPTION

Embodiments of methods and apparatus for target triggered IO classification using a computational storage tunnel are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

To meet various requirements of performance, quality of service (QoS), media endurance, and reducing cost of the solution, intelligent data placement (IO classification) between hot and capacity tiers is required. For instance, if the hot portion of workload can be recognized and classified the storage service can stage it on a hot tier, which results in higher performance and saving write cycle of the capacity tier.

To make such IO classification, the host and/or initiator cannot focus on the raw storage domain only (e.g., using an abstracted filesystem with virtual volumes). The observability features must be extended, and the system context must be considered (e.g., filesystem information, application context, operating system telemetry). As we researched, when classifying a database workload (e.g., mongodb), to improve performance and increase endurance, journal IO shall be staged on hot tier (e.g., in mongodb, each IO which belongs to files in journal directory).

From a deployment point of view, applications and storage services are separated from each other and works in different domain. For example:
Virtualization environment à Guest OS and Host/Hypervisor OS
Disaggregated/Network storage à Compute Node/Network (e.g., NVMeOF)/Target Node
   This leads to losing perception of the extended IO context and the storage service on the target/remote node cannot classify user data.

Under current approaches, the filesystem/system/application classification perception is obligatory to classify IO efficiently, however a storage disaggregation barrier (e.g., compute/target) makes it impossible because on the target side such context is invisible and not accessible.

In accordance with aspects of the embodiments disclosed herein, solutions for supporting efficient IO classification are provided. In one aspect, the target storage service notifies the initiator that it can provide an IO classifier program. The initiator downloads the program and loads/runs on the compute side. Whenever applications' IO is triggered, the IO classification program is executed. Input for the program is IO itself and other extensions like context of application, operating system, and filesystem. The program produces an IO class that is returned to the initiator's block layer and embedded to the IO (e.g., IO hint, stream id). For notification of the program availability, a computational storage protocol/tunnel is used. This solution can be perceived as a reverted computational storage. The target requests to execute a remote procedure on compute side, which is then used to direct storage data to the appropriate storage tier.

The solution can be used in a variety of compute/storage environments on one or more levels. The following discussion illustrated several non-limiting example use contexts.

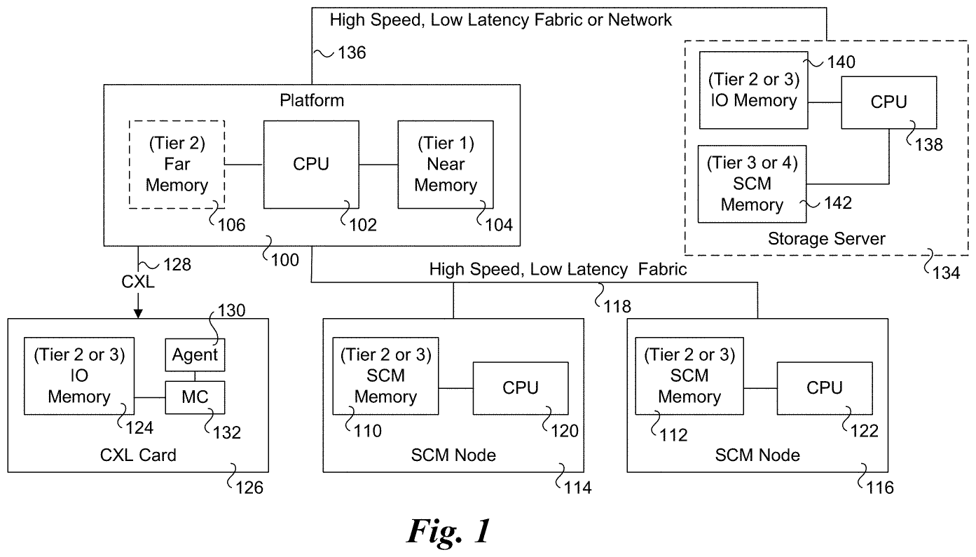

The teachings and the principles described herein may be implemented using various types of tiered memory/storage architectures. For example, FIG. 1 illustrates an abstract view of a tiered memory architecture employing four tiers: 1) “near” memory; 2) “far” memory; and 3) SCM (storage class memory); and 4) Storage Server. The terminology “near” and “far” memory do not refer to the physical distance between a CPU and the associated memory device, but rather the latency and/or bandwidth for accessing data stored in the memory device. SCM memory is a type of pooled storage/memory—when the pooled storage/memory is located in a separate chassis, sled, or drawer or in a separate rack connected over a network or fabric the pooled memory may be referred to as remote pooled memory. The storage server implements two tiers of memory in this example.

FIG. 1 shows a platform 100 including a central processing unit (CPU) 102 coupled to near memory 104 and optional far memory 106. Generally, near memory and far memory will comprise some type of volatile Dynamic Random Access Memory (DRAM), such as DDR5 (Double Data Rate 5^{th} Generation) (S)DRAM or High-Bandwidth Memory (HBM), for example. In some embodiments far memory 106 may comprise one or more NVDIMMs (Non-Volatile Dual Inline Memory Module), which employ a hybrid of volatile memory and non-volatile memory. In some embodiment, far memory 106 may comprise three-dimensional memory such as 3D crosspoint memory (e.g., Optane® memory), which is a type of storage class memory.

Compute node 100 is further connected to SCM memory 110 and 112 in SCM memory nodes 114 and 116 which are coupled to compute node 100 via a high speed, low latency fabric 118. In the illustrated embodiment, SCM memory 110 is coupled to a CPU 120 in SCM node 114 and SMC memory 112 is coupled to a CPU 122 in SCM node 116. FIG. 1 further shows a second or third tier of memory comprising IO memory 124 implemented in a CXL (Compute Express Link) card 126 coupled to platform 100 via a CXL interconnect 128. CLX card 126 further includes an agent 130 and a memory controller (MC) 132.

Under one example, Tier 1 memory comprises DDR and/or HBM, Tier 2 memory comprises 3D crosspoint memory, and Tier 3 comprises pooled SCM memory such as but not limited to 3D crosspoint memory. In some embodiments Tier 3 comprises a cold or capacity tier. In some embodiments, the CPU may provide a memory controller that supports access to Tier 2 memory. In some embodiments, the Tier 2 memory may comprise memory devices employing a DIMM form factor.

For CXL, agent 130 or otherwise logic in MC 132 may be provided with instructions and/or data to perform various operations on IO memory 124. For example, such instructions and/or data could be sent over CXL link 128 using a CXL protocol. For pooled SMC memory or the like, a CPU or other type of processing element (microengine, FPGA, etc.) may be provided on the SCM node and used to perform the various operations disclosed herein. Such a CPU may have a configuration with a processor having an integrated memory controller or the memory controller may be separate.

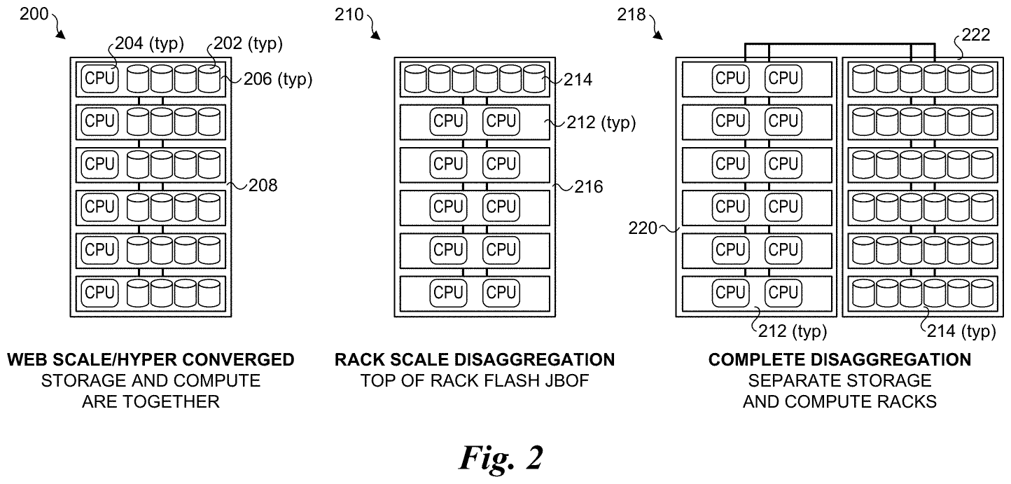

FIG. 1 further shows platform 100 connected to an optional storage server 134 over a high speed, low latency fabric or network 136. Storage server 134 includes a CPU 138 coupled to IO memory 140 and SCM memory 142. Generally, the storage resources that are accessed via a storage server may be local resources, such as IO memory, or storage resources/devices access over a fabric. In a disaggregated storage environment such as depicted in FIG. 2 and discussed below, under alternative embodiments a storage server may be either in a separate drawer/sled/chassis in the same rack as the computer node, or may be in a separate drawer/sled/chassis in a separate rack.

Resource disaggregation is becoming increasingly prevalent in emerging computing scenarios such as cloud (aka hyperscaler) usages, where disaggregation provides the means to manage resource effectively and have uniform landscapes for easier management. While storage disaggregation is widely seen in several deployments, for example, Amazon S3, compute and memory disaggregation is also becoming prevalent with hyperscalers like Google Cloud.

FIG. 2 illustrates the recent evolution of compute and storage disaggregation. As shown, under a Web scale/hyperconverged architecture 200, storage resources 202 and compute resources 204 are combined in the same chassis, drawer, sled, or tray, as depicted a chassis 206 in a rack 208. Under the rack scale disaggregation architecture 210, the storage and compute resources are disaggregated as pooled resources in the same rack. As shown, this includes compute resources 204 in multiple pooled compute drawers 212 and a pooled storage drawer 214 in a rack 216. In this example, pooled storage drawer 214 comprises a top of rack “just a bunch of flash” (JBOF). Under the complete disaggregation architecture 218 the compute resources in pooled compute drawers 212 and the storage resources in pooled storage drawers 214 are deployed in separate racks 220 and 222.

In addition to the three configurations shown in FIG. 2, a disaggregated architecture may employ a mixture of aspects of these configurations. For example, compute nodes may access a combination of local storage resources, pooled storage resources in a separate draw/sled/chassis, and/or pooled storage resources in a separate rack.

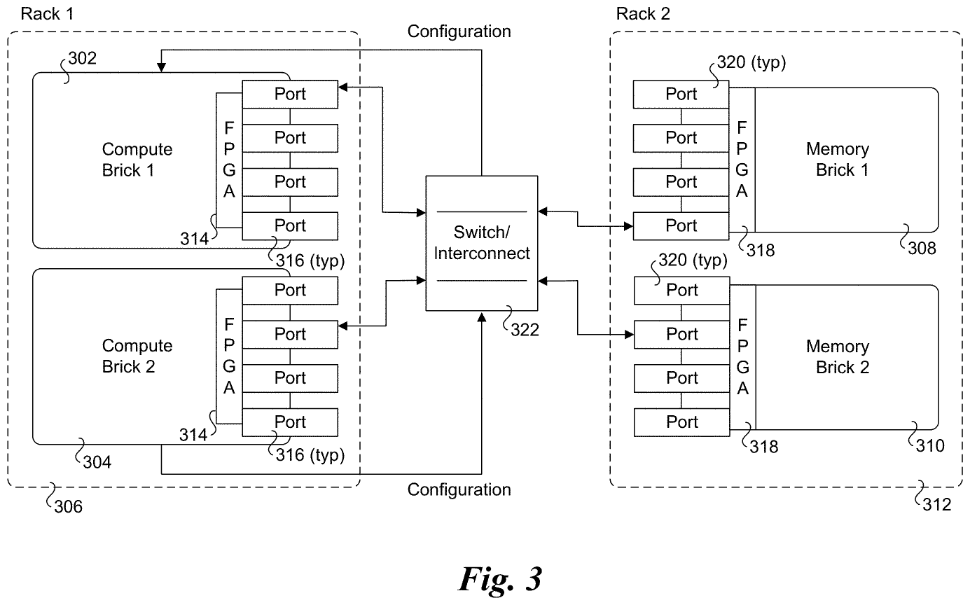

FIG. 3 shows another example of a disaggregated architecture. Compute resources, such as multi-core processors (aka CPUs (central processing units)) in blade servers or server modules (not shown) in two compute bricks 302 and 304 in a first rack 306 are selectively coupled to memory resources (e.g., DRAM DIMMs, NVDIMMs, etc.) in memory bricks 308 and 310 in a second rack 312. Each of compute bricks 302 and 304 include an FPGA (Field Programmable Gate Array) 314 and multiple ports 316. Similarly, each of memory bricks 308 and 310 include an FPGA 318 and multiple ports 320. The compute bricks also have one or more compute resources such as CPUs, or Other Processing Units (collectively termed XPUs) including one or more of Graphic Processor Units (GPUs) or General Purpose GPUs (GP-GPUs), Tensor Processing Unit (TPU) Data Processor Units (DPUs), Artificial Intelligence (AI) processors or AI inference units and/or other accelerators, FPGAs and/or other programmable logic (used for compute purposes), etc. Compute bricks 302 and 304 are connected to the memory bricks 308 and 310 via ports 316 and 320 and switch or interconnect 322, which represents any type of switch or interconnect structure. For example, under embodiments employing Ethernet fabrics, switch/interconnect 322 may be an Ethernet switch. Optical switches and/or fabrics may also be used, as well as various protocols, such as Ethernet, InfiniBand, RDMA (Remote Direct Memory Access), NVMe-oF (Non-volatile Memory Express over Fabric, RDMA over Converged Ethernet (RoCE), CXL (Compute Express Link) etc. FPGAs 314 and 318 are programmed to perform routing and forwarding operations in hardware. As an option, other circuitry such as CXL switches may be used with CXL fabrics.

Generally, a compute brick may have dozens or even hundreds of cores, while memory bricks, also referred to herein as pooled memory, may have terabytes (TB) or 10's of TB of memory implemented as disaggregated memory. An advantage is to carve out usage-specific portions of memory from a memory brick and assign it to a compute brick (and/or compute resources in the compute brick). The amount of local memory on the compute bricks is relatively small and generally limited to bare functionality for operating system (OS) boot and other such usages.

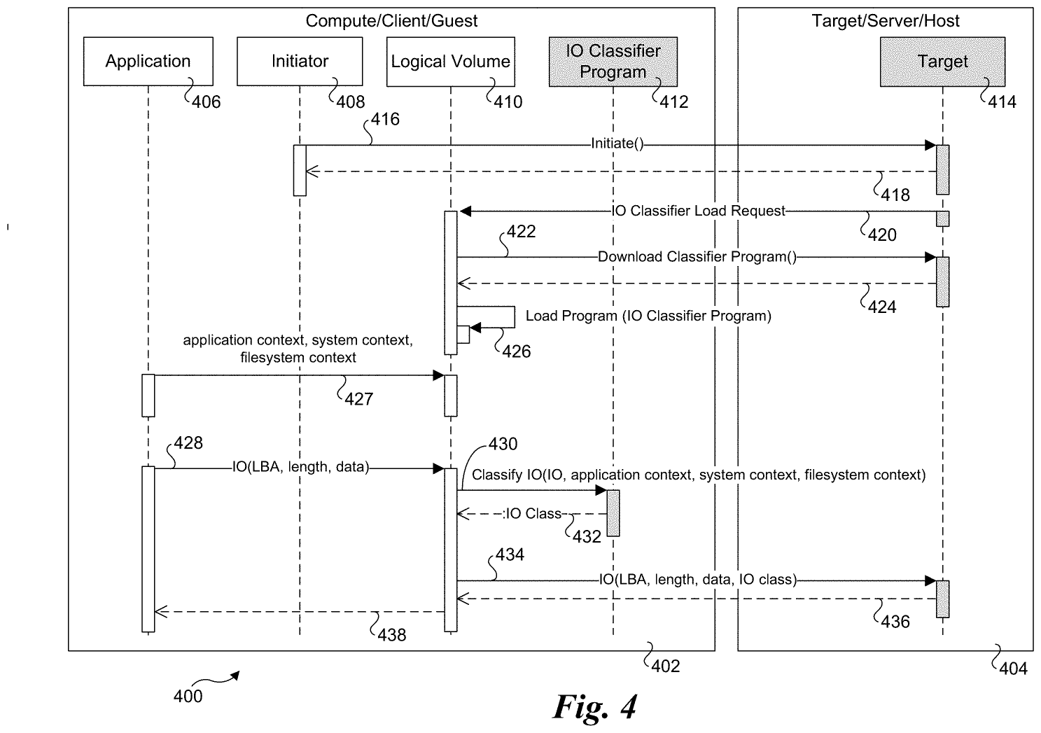

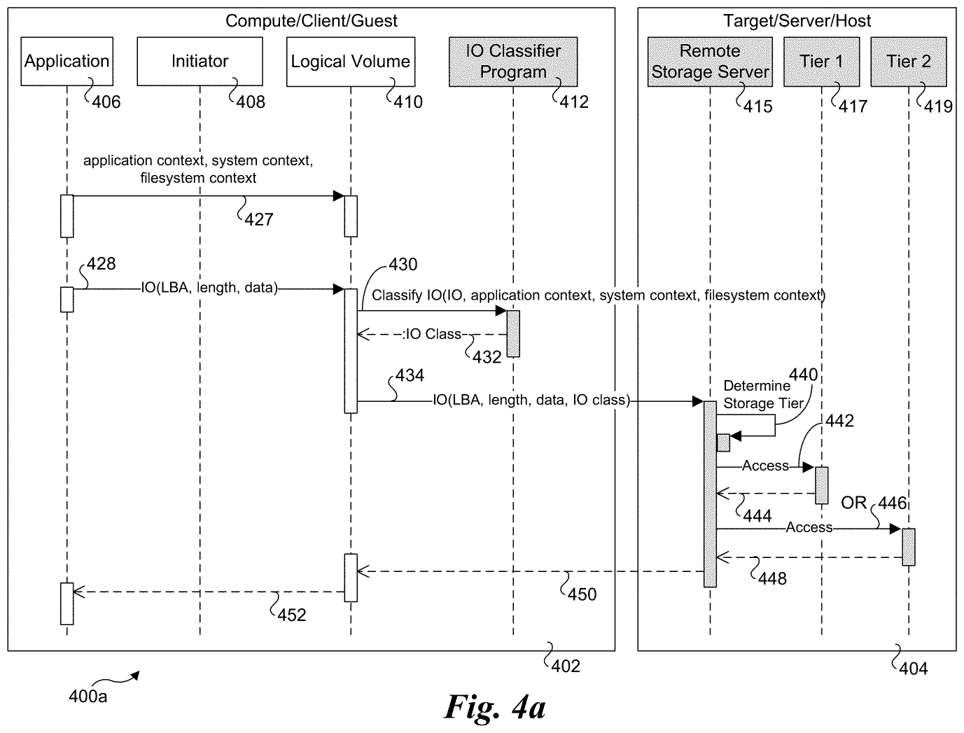

FIG. 4 shows a message flow diagram 400 that is implemented to configure an environment to support IO classification and employ IO classification for storage on a target. The message flow includes messages exchanged between a compute/client/guest 402 and a target/server/host 404, along with messages exchanged between components in compute/client/guest 402. Those components include an application 406, an initiator 408, a logical volume 410, and an IO classifier program 412. The component depicted in target/server/host 404 is a target 414 (the target). This configuration can also be described as messages exchanged between a client (402) and a server (404), where the server hosts storage resources that are accessed by the client.

The target requires IO classification based on application, operating system, and file system context. For this use case simple IO hinting based on raw block device domain is not sufficient. The storage infrastructure introduces separation between server and client so that it is not possible to interpret application-side context.

Prior to the message exchange, initiator 408 creates logical volume 410 on the compute side (402) In one aspect, logical volume 410 is a type of handler that is used by IO classifier program 412, as described below in further detail.

As message flow begins with initiator 408 sending an initiate( ) message 416 to target 414, which receives it and returns a response 418. The initiate( ) message is used to establish a communication channel to be used between client 402 and target 414.

Next, target 414 sends an asynchronous event to the client to request loading the IO classifier program, as depicted by an IO classifier load request 420. Also, it should be possible that the client can get the capabilities information to check if the classifier is available. Client 402 decides to apply the IO classifier, and sends a download classifier program( ) request 422 to target 414. The program is downloaded (depicted by return message 424) and loaded into client's environment, as depicted by operation 426.

As depicted by message flow 427, one or more of an application context, system context, and filesystem context is received by logical volume 410. One or more of these contexts is obtained by the IO classification program using APIs provided by the execution environment (e.g., a BPF program has an API provided by the Linux kernel). Examples of Application contexts include application name and PID (program identifier). Examples of system contexts include CPU core number on which IO is issued. Examples of Filesystem contexts include File name/location, File size, File extension, Offset in file, and IO is part of filesystem metadata.

For simplicity, the application context, system context, and filesystem context are shown in FIG. 4 as being forwarded from application 406; in practice, one or more operating system components may be used to obtain this information. For example, when logical volume 410 handles the IO and the logical volume is implemented in the OS kernel, the kernel can retrieve what above scheduled the IO. Before invoking the IO classification program, these values are prepared, selected and passed to the programs as arguments, in one embodiment.

The foregoing prepares the client for implementing the IO classifier program for subsequent IO requests to access storage resources on target 414. It is noted that one or more of the application context, system context, and filesystem context may change while an application is running, such that corresponding information is updated, if applicable, during run-time operations. For example, some of these values may be obtained using telemetry data generated by the operating system or other system software components.

When the application issues an IO request, the IO classifier program is executed. The program returns an IO class based on input delivered by the client's operating system. The program can be able to read and recognize application context, system context and filesystem context corresponding to the IO request (e.g., by looking at the source of the IO request, which in this example flow is application 406). The returned IO class (hint) is added to the IO protocol request and sent to the target side. There it can be intercepted, and data can be persisted respectively to the value of IO hint.

The foregoing is depicted in FIG. 4 as follows. Application 406 submits an IO request 428 including a logical block address (LBA), length, and data to logical volume 410. In response, logical volume 410 issues a classify IO request 430 to IO classifier program 412. Classify IO request 430 includes the IO information in IO request 428, along with the application context, system context, and filesystem context, which the IO classifier program is enabled to read and recognize. In response to classify IO request 430, IO classifier program 412 returns an IO class 432 to logical volume 410, which operates as a hint to be used by the target to determine what storage tier on the target should be used.

Next, logical volume 410 sends an IO request 434 to target 414 including the LBA, length, data of the original IO request 428 plus the IO class (hint) returned by the IO classifier program. Target 414 then uses the IO class hint to determine on what tier to store the data. Upon success, target 414 returns a completion status in a message 436 to logical volume 410, which forwards the completion status via a message 438 from the logical volume to application 406.

FIG. 4a is a message flow diagram 400a illustrating a portion of messages and associated operations when the target is a remote storage server 415. In this example, remote storage server 415 provides access to two storage tiers 417 (Tier 1) and 419 (Tier 2). The tier level is relative to the remote storage servers and opposed to being relative to the entire system. For example, in some examples the storage tiers may be implemented as Tier 2 and Tier 3 in a system. In other examples, the storage tiers may be implemented as Tier 3 and Tier 4. The physical memory used for storage tiers 417 and 419 may be co-located with remote storage server 415 (e.g., residing within either the same chassis/drawer/sled as a remote storage server) and/or may be accessed via the remote storage, such as SCM coupled to the remote storage server via a fabric.

In FIG. 4a, the message flow prior to message 427 is the same as in FIG. 4, recognizing that target 414 has been replaced with remote storage server 415. The messages and operations through IO request 434 are the same in both message flow diagram 400 and 400a. Upon receipt of IO request 434, remote storage server 415 extracts the IO class to determine on which tier the provided data is to be stored, as depicted by the determine storage tier operation 440. If it is determined the data are to be stored in tier 417, remote storage server 415 sends a storage access request 442 with the data to tier 417, which stores the data and returns a confirmation 444 indicating the data have been successfully stored. (If unsuccessful, then a failure notification will be returned rather than confirmation 444.). If it is determined the data are to be stored in tier 419, remote storage server 415 sends a storage access request 448 with the data to tier 419, which stores the data and returns a confirmation 446 (if successful) or a failure notification if unsuccessful. indicating the data have been successfully stored. Upon success, remote storage server 415 returns a completion status in a message 450 to logical volume 410, which forwards the completion status via a message 452 from the logical volume to application 406.

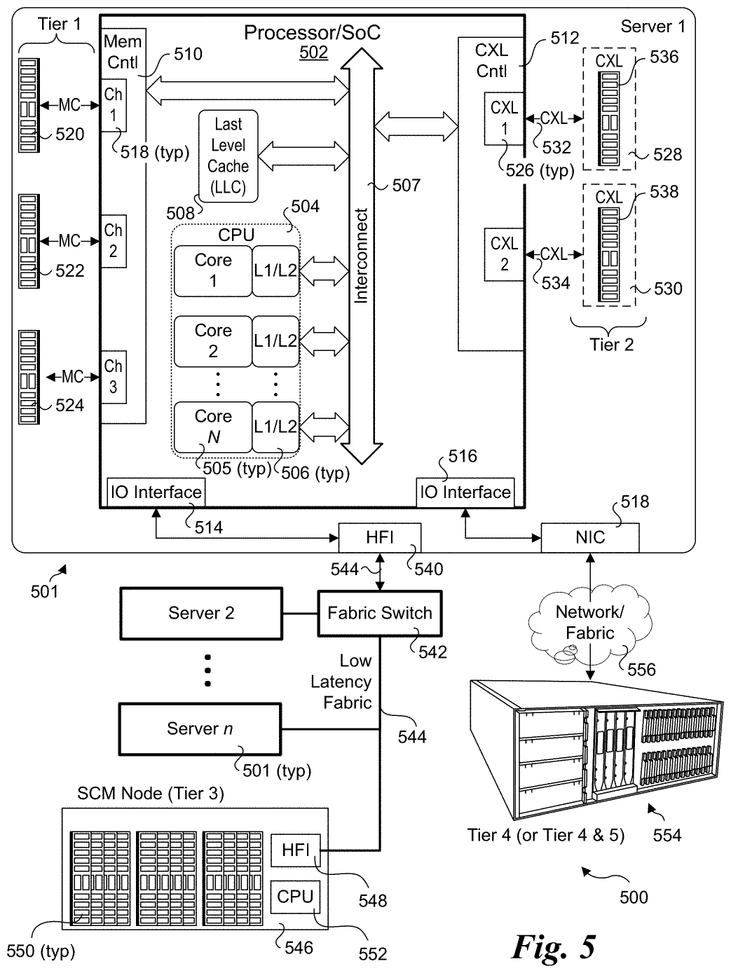

As shown in FIG. 5 and discussed below, in some embodiments CXL DIMMs may be used that are coupled to a CLX controller on an SoC/Processor/CPU via a CXL DIMM socket or the like. In this instance, the CXL DIMMs are not installed in a CXL card.

FIG. 5 shows a cloud environment 500 in which four memory tiers are implement. Cloud environment 500 includes multiple compute platforms comprising servers 501 that are also referred as servers 1-n. Server 501 includes a processor/SoC 502 including a CPU 504 having N cores 505, each with an associated L1/L2 cache 506. The cores/L1/L2 caches are coupled to an interconnect 507 to which an LLC 508 is coupled. Also coupled to interconnect 507 is a memory controller 510, a CXL controller 512, and IO interfaces 514 and 516. Interconnect 507 is representative of an interconnect hierarchy that includes one or more layers that are not shown for simplicity.

Memory controller 510 includes three memory channels 518, each connected to a respective DRAM or SDRAM DIMM 520, 522, and 524. CXL controller 512 includes two CXL interfaces 526 connected to respective CXL memory devices 528 and 530 via respective CXL flex-busses 532 and 534. CXL memory devices 528 and 530 include DIMMs 536 and 538, which may comprise CXL DIMMs or may be implemented on respective CXL cards and comprising any of the memory technologies described above.

IO interface 514 is coupled to a host fabric interface (HFI) 540, which in turn is coupled to a fabric switch 542 via a fabric link in a low-latency fabric 544. Also coupled to fabric switch 542 are server 2 . . . server n and an SCM node 546. SCM node 546 includes an HFI 548, a plurality of SCM DIMMs 550, and a CPU 552. Generally, SCM DIMMs may comprise NVDIMMs or may comprise a combination of DRAM DIMMs and NVDIMMs. In one embodiment, SCM DIMMs comprise 3D crosspoint DIMMs.

IO interface 516 is coupled to a NIC 518 that is coupled to a remote memory server 554 via a network/fabric 556. Generally, remote memory server 554 may employ one or more types of storage devices. For example, the storage devices may comprise high performance storage implemented as a hot tier and lower performance high-capacity storage implemented as a cold or capacity tier. In some embodiment, remote memory server 554 is operated as a remote memory pool employing a single tier of storage, such as SCM.

As further shown, DRAM/SDRAM DIMMs 520, 522, and 524 are implemented in memory tier 1 (also referred to herein as local memory or near memory), while CXL devices 528 and 530 are implemented in memory/storage tier 2. Meanwhile, SCM node 546 is implemented in memory/storage tier 3, and memory in remote memory server 554 is implemented in memory/storage tier 4 or memory/storage tiers 4 and 5. In this example, the memory tiers are ordered by their respective latencies, wherein tier 1 has the lowest latency and tier 4 (or tier 5) has the highest latency.

It will be understood that not all of cloud environment 500 may be implemented, and that one or more of memory/storage tiers 2, 3, and 4 (or 4 and 5) will be used. In other words, a cloud environment may employ one local or near memory tier, and one or more memory/storage tiers.

The memory resources of an SCM node may be allocated to different servers 501 and/or operating system instances running on servers 501. Moreover, a memory node may comprise a chassis, drawer, or sled including multiple SCM cards on which SCM DIMMs are installed.

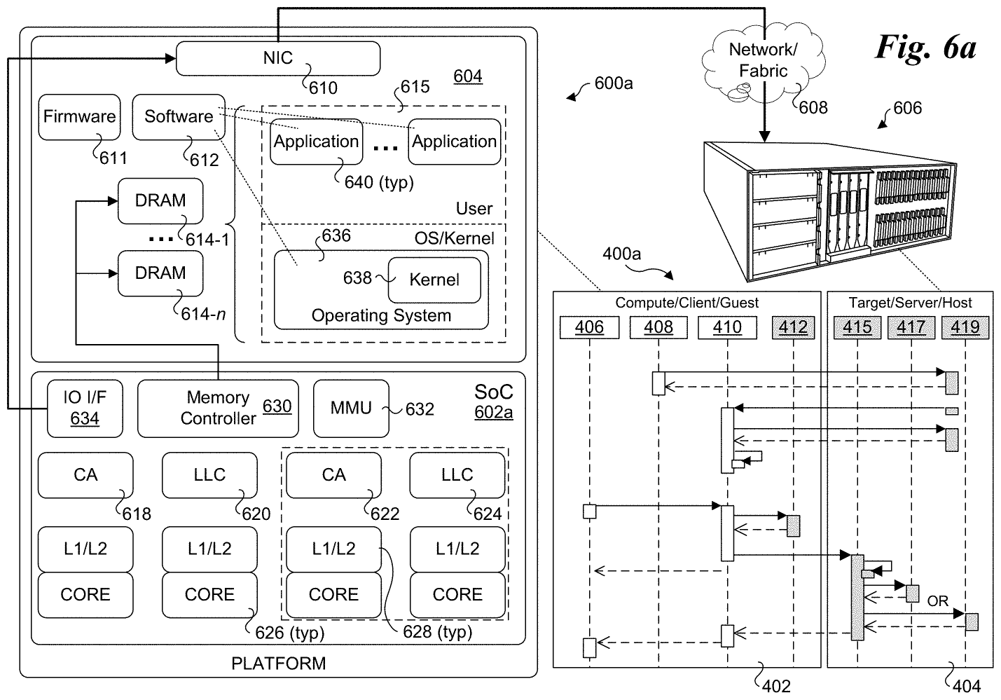

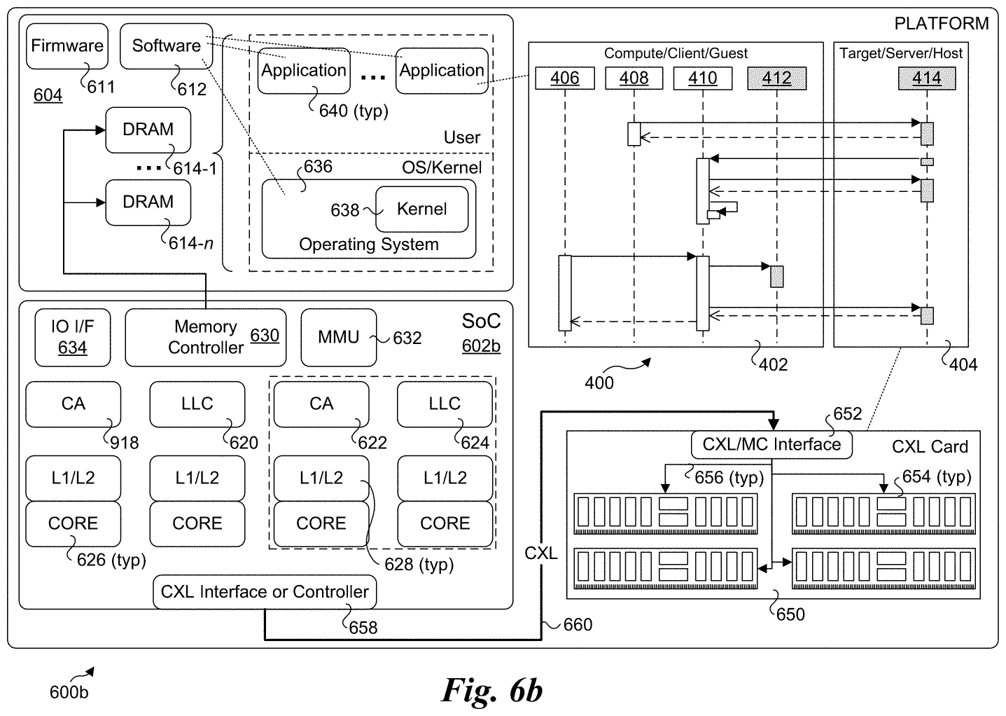

FIG. 6a shows a high-level view of a system architecture according to an exemplary implementation of a system in which remote pooled memory is used in a far memory/storage tier. The system includes a compute platform 600a having an SoC (aka processor or CPU) 602a and platform hardware 604 coupled to a storage server 606 via a network or fabric 608. Platform hardware 604 includes a network interface controller (NIC) 610, a firmware storage device 611, a software storage device 612, and n DRAM devices 614-1 . . . 614-n. SoC 602a includes caching agents (CAs) 618 and 622, last level caches (LLCs) 620 and 624, and multiple processor cores 626 with L1/L2 caches 628. Generally, the number of cores may range from four upwards, with four shown in the figures herein for simplicity. Also, an SoC/Processor/CPU may include a single LLC and/or implement caching agents associated with each cache component in the cache hierarchy (e.g., a caching agent for each L1 cache, each L2 cache, etc.)

In some embodiments, SoC 602a is a multi-core processor System on a Chip with one or more integrated memory controllers, such as shown depicted by a memory controller 630. SoC 602a also includes a memory management unit (MMU) 632 and an IO interface (UF) 634 coupled to NIC 610. In one embodiment, IO interface 634 comprises a Peripheral Component Interconnect Express (PCIe) interface.

Generally, DRAM devices 614-1 . . . 614-n are representative of any type of DRAM device, such as DRAM DIMMs and Synchronous DRAM (SDRAM) DIMMs. More generally, DRAM devices 614-1 . . . 614-n are representative of volatile memory, comprising local (system) memory 615.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM, or some variant such as SDRAM. A memory subsystem as described herein can be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4 (LPDDR version 4, JESD209-4, originally published by JEDEC in August 2014), WIO2 (Wide Input/Output version 2, JESD229-2 originally published by JEDEC in August 2014), HBM (High Bandwidth Memory, JESD325, originally published by JEDEC in October 2013), DDR5 (DDR version 5, currently in discussion by JEDEC), LPDDR5 (currently in discussion by JEDEC), HBM2 (HBM version 2, currently in discussion by JEDEC), or others or combinations of memory technologies, and technologies based on derivatives or extensions of such specifications. The JEDEC standards are available at www.jedec.org.

Software storage device 612 comprises a nonvolatile storage device, which can be or include any conventional medium for storing data in a nonvolatile manner, such as one or more magnetic, solid state, or optical based disks, or a combination. Software storage device 612 holds code or instructions and data in a persistent state (i.e., the value is retained despite interruption of power to compute platform 600a). A nonvolatile storage device can be generically considered to be a “memory,” although local memory 615 is usually the executing or operating memory to provide instructions to the cores on SoC 602a.

Firmware storage device 611 comprises a nonvolatile memory (NVM) device. A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), Penta-level cell (“PLC”) or some other NAND. An NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

Software components in software storage device 612 are loaded into local memory 615 to be executed on one or more cores 626 on SoC 602a. The software components include an operating system 636 having a kernel 638 and applications 640. The address space of local memory 615 is partitioned into an OS/kernel space in which Operating system 636 and kernel 638 are stored, and a user space in which applications 640 are stored.

The address space allocated to applications (and their processes) is a virtual address space that may be extended across multiple memory tiers, including a memory tier in remote memory pool 606. The cloud service provider (CSP) or the like may allocate portions of the memory in remote memory pool 606 to different platforms (and/or their operating systems instances).

FIG. 6b shows a high-level view of a system architecture including a compute platform 600b in which a CXL memory card 650 is implemented in a local memory/storage tier. CXL card 650 includes a CXL/MC (memory controller) interface 652 and four DIMMs 654, each connected to CXL/MC interface 652 via a respective memory channel 656. CXL/MX interface 652 is connected to a CXL interface or controller 658 on an SoC 602b via a CXL link 660, also referred to as a CXL flex-bus.

The labeling of CXL interface or controller 658 and CXL/MC interface 652 is representative of two different configurations. In one embodiment, CXL interface or controller 658 is a CXL interface and CXL/MX interface 652 is a CXL interface with a memory controller. Alternatively, the memory controller may be coupled to the CXL interface. In another embodiment, CXL interface or controller 658 comprises a CXL controller in which the memory controller functionality is implemented, and CXL/MX interface 652 comprises a CXL interface. It is noted that memory channels 656 may represent a shared memory channel implemented as a bus to which DIMMs 654 are coupled.

Generally, DIMMs 654 may comprising DRAM DIMMs or hybrid DIMMS (e.g., 3D crosspoint DIMMs). In some embodiments, a CXL card may include a combination of DRAM DIMMs and hybrid DIMMs. In yet another alternative, all or a portion of DIMMs 654 may comprise NVDIMMs.

As further shown in FIG. 6a, under the architecture represented in the message flow diagram 400a, compute platform 600a corresponds to a compute implementation of compute/client/guest 402, while storage server 606 corresponds to server implementation of target/server/host 404. Under the configuration of FIG. 6b, compute platform 600b is a compute implementation of compute/client/guest 402, while CXL card 650 is a target implementation of target/server/host 404.

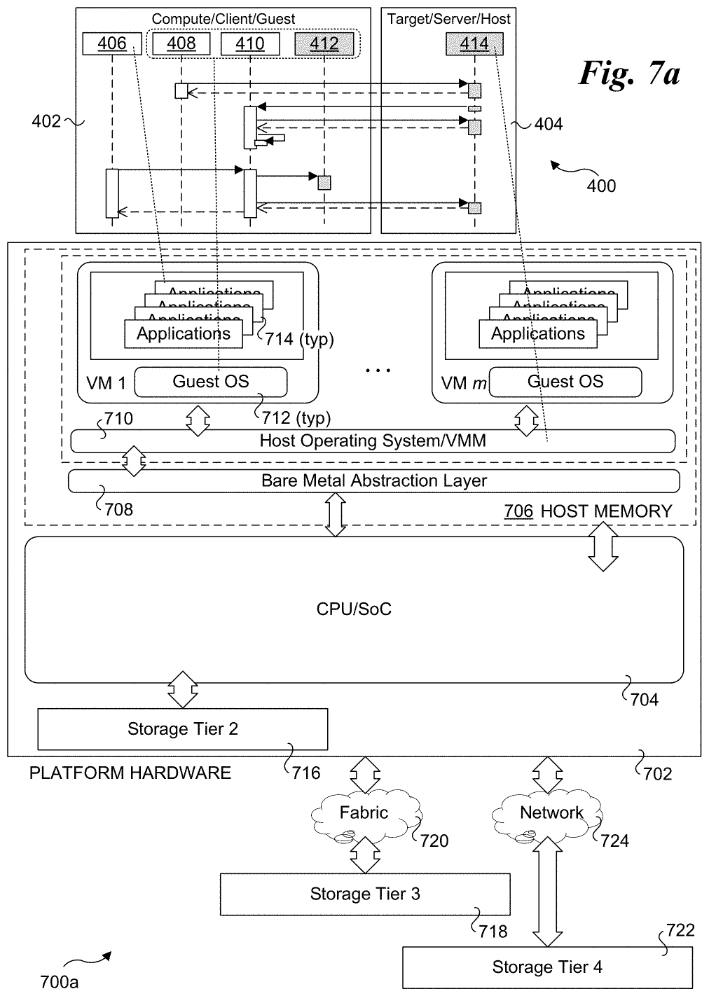

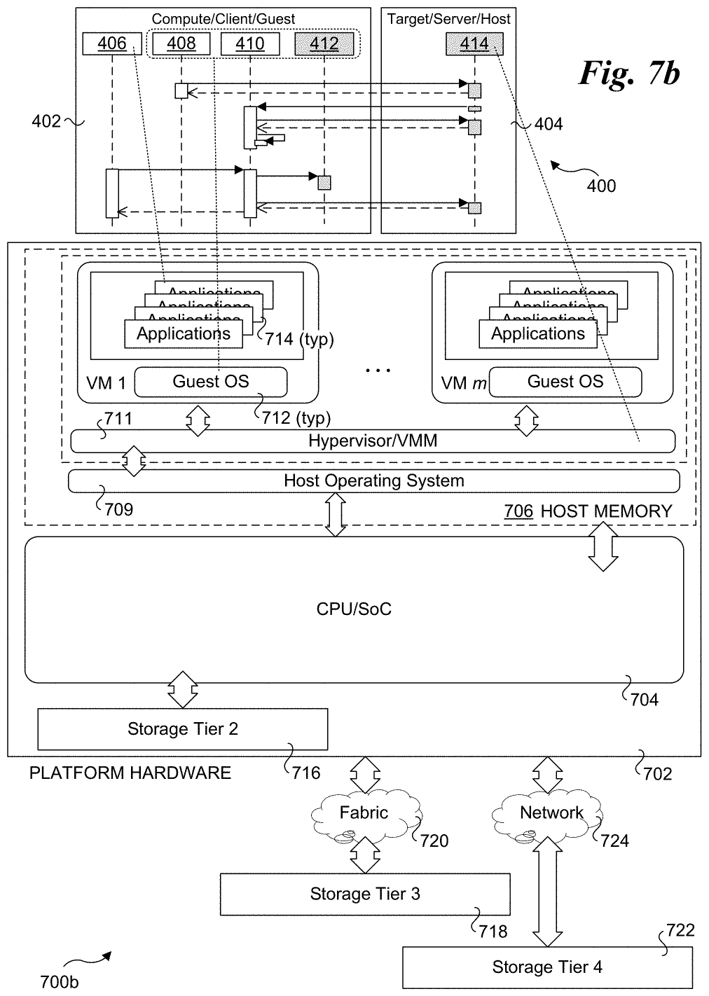

Under some embodiments, the storage disaggregation barrier comprises a virtualization layer in a virtualized platform. Non-limiting examples of virtualized platforms are shown in FIGS. 7a and 7b. FIG. 7a shows an embodiment of a bare metal cloud platform architecture 700a comprising platform hardware 702 including a CPU/SoC 704 coupled to host memory 706 in which various software components are loaded and executed. The software components include a bare metal abstraction layer 708, a host operating system 710, and m virtual machines VM 1 . . . VM m, each having a guest operating system 712 on which a plurality of applications 714 are run.

In some deployments, a bare metal abstraction layer 708 comprises a Type-1 Hypervisor. Type-1 Hypervisors run directly on platform hardware and host guest operating systems running on VMs, with or without an intervening host OS (with shown in FIG. 7a). Non-limiting examples of Type-1 Hypervisors include KVM (Kernel-Based Virtual Machine, Linus), Xen (Linux), Hyper-V (Microsoft Windows), and VMware vSphere/ESXi.

Bare metal cloud platform architecture 700a also includes three storage tiers 716, 718, and 722, also respectively labeled Storage Tier 2, Storage Tier 3, and Storage Tier 4. Storage tier 716 is a local storage tier that is part of platform hardware 702, such as a CXL card or CXL DIMM, an NVDIMM, or a 3D crosspoint DIMM. Other form factors may be used, such as M.2 memory cards or SSDs. Storage tier 718 is coupled to platform hardware 702 over a fabric 720, while storage tier 722 is coupled to platform hardware 702 over a network 724. In some embodiments, only one of storage tiers 718 and 722 may be employed. In one embodiment, storage tier 718 employs SCM storage. In one embodiment storage tier 4 is implemented with a storage server that may have one or more tiers of storage.

As further shown toward the top portion of FIG. 7, compute/client/guest 402 in message flow diagram 400 is implemented in guest, while target/server/host 404 is implemented as a host in host operating system 710. Application 406 is mapped to one of applications 714, while initiator 408, logical volume 410, and IO classifier program 412 are implemented in guest OS 712.

FIG. 7b shows an embodiment of platform architecture 700b employing a Type-2 Hypervisor or Virtual Machine Monitor (VMM) 711 that runs over a host operating system 709. As depicted by like-numbered blocks and components in FIGS. 7a and 7b most of the blocks and components are the same under both architectures 700a and 700b. In the case of platform architecture 700b, target 414 is implemented in hypervisor/VMM 711 in the illustrated embodiment.

In one embodiment, a deployment employing a Linux operating system can be based on eBPF functionality and the NVMeOF (Non-volatile Memory Express over Fabric) protocol. eBPF (https://ebpf.io) is a mechanism for Linux applications to execute code in Linux kernel space.

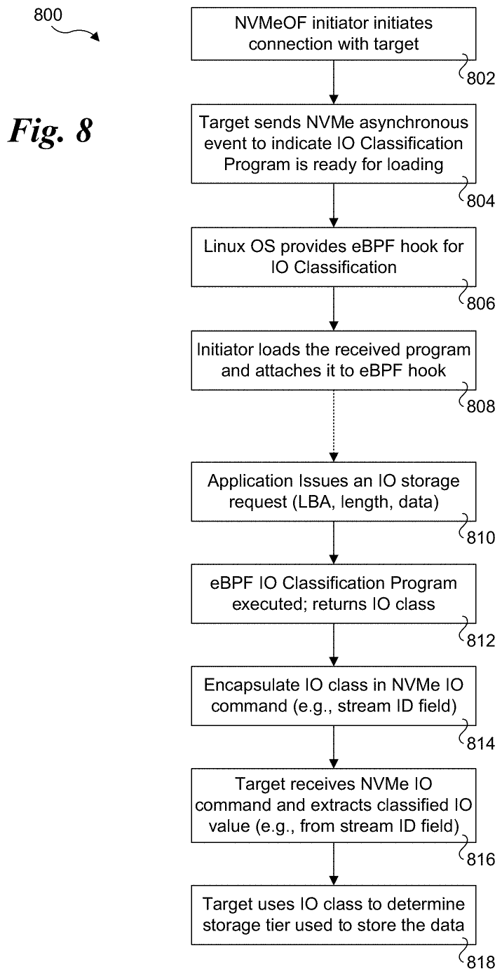

With reference to Flowchart 800 in FIG. 8, the deployment operates as follows. The flow begins with the NMVeOF initiator initiating a connection with a target in a block 802. When the NVMeOF initiator and target are set, the target sends an NVMe asynchronous event that indicates the IO classification program is ready for loading in a block 804. The program is developed using eBPF technology. In a block 806, the Linux operating system, in the block device layer, provides the eBPF hook for IO classification. This runs a registered eBPF program to generate the IO class. The hook can be configured which IO context and telemetry can be passed to the program. In a block 808 the initiator loads the received program and attaches it to the hook corresponding to the logical volume. This completes the set-up phase, which is followed by a process flow for supporting IO storage requests.

This flow begins in a block 810 in which an application issues an IO storage request with LBA, length, and data). Whenever an application issues an IO request then the eBPF IO classification program is executed and it returns an IO class (e.g., a numeric value), as depicted in a block 812. In a block 814, this IO class value is encapsulated in an NVMe IO command using the stream ID field, in one embodiment. In a block 816, the target receives the NVMe IO commands and extracts the classified IO value by inspecting the stream ID field in the received NVMe IO command. In a block 818, the target then uses the IO class to determine what storage tier to use to store the data.

The classifier can be easily exchanged, for example, first the target can perform preliminary recognition of the client environment (e.g., looking for a specific application), and then can request to reload a new program specialized for the client's environment. The client's operating system doesn't have to be modified/patched/updated/restarted. In one embodiment, at any time the target can resend the asynchronous event for reloading the IO classification program, or loading a new IO classification program.

Some of the foregoing embodiments may be perceived as a reverted computational storage. For example, under an extension, the target requests to execute a remote procedure on compute side. The scope of the procedure doesn't have to be limited to IO classification. The target can schedule other procedures. For example, in one embodiment the target can recognize the client capabilities and it discovers an accelerator for compression; it loads the program to compress IO data before sending over the network for reducing network load. In another embodiment, the target recognizes a read workload locality; it loads the program which provides read cache functionality.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, implemented in an environment including a compute platform having system memory, comprising:
implementing a multi-tier memory and storage scheme employing multiple tiers of memory and storage supporting different Input-Output (IO) classes;
loading an IO classification program into the system memory;
for an IO storage request originating from an application running on the compute platform,
determining, via execution of the IO classification program, an IO class to be used for the IO storage request; and
forwarding the IO storage request to a device implementing a memory or storage tier supporting the IO class or via which a device implementing a memory or storage tier supporting the IO class can be accessed.

2. The method of claim 1, wherein the IO class is determined based on one or more of an application context, a system context, and a filesystem context associated with the IO storage request.

3. The method of claim 2, further comprising:
accessing, from at least one of an application, an operating system, and the IO classification program running on the compute platform, one or more of an application context, a system context, and a filesystem context; and
determining the IO class based on one or more of the application context, the system context, and the filesystem context associated with the IO storage request.

4. The method of claim 1, wherein the IO storage request employs the Non-volatile Memory Express over Fabric (NVMeOF) protocol.

5. The method of claim 4, further comprising encapsulating the IO class in an NVMe IO command.

6. The method of claim 1, wherein the compute platform is running a Linux operating system (OS) including a kernel and wherein the IO classification program is a registered eBPF program in the Linux kernel.

7. The method of claim 1, further comprising:
downloading the IO classification program from a target in the environment, the target implementing one or more tiers of storage.

8. The method of claim 1, wherein the device to which the IO storage request is forwarded comprises a remote storage server.

9. The method of claim 1, wherein the remote storage server provides access to a first storage tier associated with a first IO class and a second storage tier associated with a second IO class, further comprising:
receiving, at the remote storage server, and IO storage request including the IO class; and
storing, via the remote storage server, data associated with the IO storage request in the first storage tier or second storage tier based on the IO class in the IO storage request.

10. The method of claim 1, wherein the compute platform employs virtualization including one of a virtualization layer, hypervisor, or virtual machine manager (VMM), and wherein the IO classifier program is implemented in the virtualization layer, hypervisor, or VMM.

11. A non-transitory machine-readable medium having instructions stored thereon configured to be executed on a processor in a compute platform including system memory and implemented in an environment including a multi-tier memory and storage scheme employing multiple tiers of memory and storage supporting different Input-Output (IO) classes, wherein execution of the instructions enables the compute platform to:
for an IO storage request originating from an application running on the compute platform,
determining, via execution of instructions comprising an IO classification program, an IO class to be used for the IO storage request; and
forward the IO storage request to a device implementing a memory or storage tier supporting the IO class or via which a device implementing a memory or storage tier supporting the IO class can be accessed.

12. The non-transitory machine-readable medium of claim 11, wherein execution of the instructions further enables the compute platform to:
access, from at least one of an application and an operating system running on the compute platform, one or more of an application context, a system context, and a filesystem context; and
determine one or more of the application context, the system context, and the filesystem context are associated with the IO storage request; and
determine the IO class based on the one or more of the application context, the system context, and the filesystem context associated with the IO storage request.

13. The non-transitory machine-readable medium of claim 11, wherein the IO storage request employs the Non-volatile Memory Express over Fabric (NVMeOF) protocol, and wherein execution of the instructions enables the compute platform to encapsulate the IO class in an NVMe IO command.

14. The non-transitory machine-readable medium of claim 11, wherein the compute platform is configured to run a Linux operating system (OS) including a kernel and wherein the IO classification program is a registered eBPF program in the Linux kernel.

15. The non-transitory machine-readable medium of claim 11, wherein the instructions comprise a plurality of software components including an initiator, a logical volume driver, and the IO classification program.

16. The non-transitory machine-readable medium of claim 11, wherein the compute platform employs virtualization including one of a virtualization layer, hypervisor, or virtual machine manager (VMM), and wherein the IO classifier program is implemented in the virtualization layer, hypervisor, or VMM.

17. A system, implemented in a data center environment, comprising:
a compute platform comprising a processor operatively coupled to system memory and two or more storage tiers supporting different Input-Output (IO) classes; and
software configured to be executed on the processor to enable the compute platform to,
for an IO storage request originating from an application running on the compute platform,
determine an IO class to be used for the IO storage request; and
forward the IO storage request to storage tier supporting the IO class or via which a device implementing a storage tier supporting the IO class can be accessed.

18. The system of claim 17, wherein the software includes an IO classification program that is executed to determine the IO class to be used for the IO storage request

19. The system of claim 18, wherein the compute platform is configured to run a Linux operating system (OS) including a kernel and wherein the IO classification program is a registered eBPF program in the Linux kernel.

20. The system of claim 18, wherein the compute platform employs virtualization including one of a virtualization layer, hypervisor, or virtual machine manager (VMM), and wherein the IO classifier program is implemented in the virtualization layer, hypervisor, or VMM.
